(19) United States
(12) Patent Application Publication
(10) Pub. No.: US 2025/0365070 A1
(43) Pub. Date: Nov. 27, 2025

(54) POLAR FILTERING COMMUNICATION SYSTEM AND METHOD THEREOF

(71) Applicant: The United States of America, as Represented by the Secretary of the Navy, Arlington, VA (US)

(72) Inventors: Don Edward Barber, JR., Pacific Grove, CA (US); Murali Tummala, Monterey, CA (US); John Colin McEachen, II, Carmel-by-the-Sea, CA (US)

(21) Appl. No.: 18/961,763

(22) Filed: Nov. 27, 2024

Related U.S. Application Data
(60) Provisional application No. 63/651,462, filed on May 24, 2024.

(51) Int. Cl. H04B 10/116; G02B 5/30; H04B 10/61

(52) U.S. Cl. CPC H04B 10/116; G02B 5/3025; H04B 10/6151

(57) ABSTRACT

A visible light communication apparatus comprising: multiple sources, at least one source being a light source configured to transmit a data signal; and a receiver comprising a polarizer, operating in a visible light spectrum, the receiver configured to receive visible light energy from the one or more sources; the polarizer configured to filter multiple noise signals and allow the data signal to pass through to the receiver. Allows more signal light than background light to reach the sensor, the polarizer improves signal to noise ratio for outdoor visible light communication.

### CROSS-REFERENCE TO RELATED APPLICATIONS

This patent application is takes priority from U.S. Provisional Patent Application No. 63/651,462, filed on May 24, 2024, titled Improved Visible Light Communication System and Method Thereof, the contents of which are expressly incorporated herein by this reference as though set forth in their entirety and to which priority is claimed.

### STATEMENT OF GOVERNMENT INTEREST

The present disclosure was made in the performance of official duties by one or more employees of the Department of the Navy, and thus, embodiments herein may be manufactured, used or licensed by or for the Government of the United States of America for governmental purposes without the payment of any royalties thereon or therefor.

### FIELD OF USE

The present disclosure relates, in general, to a system and method of improving visible light communications. More specifically, the present disclosure relates to a method and system of improving the range and data rates of a visible light communications system using polarization to improve signal-to-noise ratio.

### BACKGROUND

Generally, Visible light communication (VLC) is a wireless technology that uses visible light to transmit information. VLC systems typically use light-emitting diode (LED) transmitters to modulate the visible light used for illumination, which a photodetector or image sensor can receive. VLC systems can provide high-speed wireless data transmission and lighting simultaneously.

VLC systems may be used in advanced driver assistance systems (ADAS), such as those used in the automotive industry, to adapt or enhance vehicle systems to increase safety and provide better driving. In such systems, safety features are designed to avoid collisions and accidents by offering technologies that alert the driver to potential problems or to avoid collisions by implementing safeguards and taking over control of the vehicle.

Typically, VLC systems use photodetectors, image sensors, photodiodes, photoresistors, phototransistors, and photovoltaic light sensors. These light sensors have some disadvantages, such as short transmission coverage: VLC systems have traditionally been limited to a few hundred meters, restricting them from long-distance communication because of noise and ease of being obstructed or blocked in a VLC communication channel.

The goal of a VCL system, leveraging light sources, is to improve range, robustness, and data rates. The main metric in quantifying the capability of a communication system is signal-to-noise (SNR). SNR is the ratio of signal power divided by noise power in decibel form: SNRdb=10 Log 10 SNR. Rather than measuring individual system parameters, an SNR may establish high, middle, and low SNR ratios for acceptable performance.

Intense ambient light, interference from other light sources, optoelectronic thermal energy, sensors with large detection areas, high dark currents, and capacitance can introduce noise to a received signal. Simply increasing transmitted power does not necessarily and sufficiently improve SNR.

Previous techniques include assuming the greatest received signal is the intended transmitted signal. This assumption could potentially lead to environmental noise being interpreted as the intended transmitted signal, leading to increased error rates in discrete systems and distorted signals in continuous systems. Broadband frequency anomaly detection of localized data sources also produced errors because dynamic noise elements were interpreted as intended transmitted data, such as optical perturbation of high contrast areas producing stronger frequency components. Environmental oscillations from water surfaces, trees, and fans appear to modulate reflected light energy.

The potential of VLC systems and intelligent transportation systems is currently limited by the range, and data rates are limited by noise. Therefore, a method and system that improves the SNR of a received signal from an intended transmitted signal is needed.

### SUMMARY

To minimize the limitations in the prior art, and to minimize other limitations that will become apparent upon reading and understanding the present specification, the present disclosure discloses a new and useful system and method of improving visible light communications.

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented herein below. It is to be understood that both the following general description and the following detailed description are exemplary and explanatory only and are not restrictive.

The problem with noisy environments of VLC systems is solved by filtering noise energy with a polarizer to improve SNR.

A visual light communication (VLC) system may be a wireless technology used for communication between one or more vehicles and utilized in advanced driver assistance systems (ADAS) and must contend with significant background noise, which reduces the signal-to-noise ratio (SNR) and channel throughput. Increasing the SNR may improve communication range and/or data rates.

A VLC system may utilize lighting systems already in use to transmit data. The VLC transmitter may encode data in a polarized transmitted data signal. A VLC receiver may have a polarizer that may filter noise from a transmitted signal.

Selective gain may be improved using polarization filters by increasing SNR. Taking advantage of typical external light sources of noise, such as headlights and streetlamps, and being unpolarized, a vertical linear polarizer may be used to filter approximately 50% of the external light source energy.

Linear polarization may be implemented by a simple polarizing film or lens placed in front of the existing vehicle imaging sensors,

There is no need to redesign a camera and a linear polarizer may be placed in front of the existing optics and circuitry,

Low-cost polarization filters may allow for the retrofit of existing camera-based communication systems and their low-cost inclusion in new designs. Outdoor communication systems that use cameras for communication and other functions, such as rear-view and lane assist on vehicles, for example, including polarization filters, may also increase contrast and improve performance on non-communication features.

One embodiment of a visible light communication apparatus comprising: multiple sources, at least one source being a light source configured to transmit a data signal; and a receiver comprising a polarizer and operating in a visible light spectrum, the receiver configured to receive visible light energy from the one or more sources; the polarizer configured to filter multiple noise signals and allow the data signal to pass through to the receiver. Wherein the polarizer is configured to be adjusted based at least in part on the polarization of the data signal, multiple noise signals, and a signal-to-noise ratio (SNR). The polarizer is configured to be adjusted for a maximum signal-to-noise ratio (SNR) and to stop adjusting when the maximum SNR is reached. Wherein the polarizer is an electronic shudder polarizer. Wherein the polarizer is a rotating polar filter. Wherein at least one of the sources is a light emitting diode. Wherein a polarizer adjustment is based at least in part on a desired signal to noise ratio. Wherein the polarizer adjustment is further adjusted based on a variation in the angle of the received noise energy. Wherein the polarizer adjustment corresponds to gains relating to I_{Tx}=I_{Inc} cos² θ.

Another embodiment may be a vehicle comprising a visible light communication apparatus, where the visible light communication apparatus comprises: a receiver; multiple sources; and a polarizer; the receiver being configured to receive a data signal and noise through a polarizer; wherein the polarizer is configured to filter a multiple noise signals; wherein at least one of the sources transmits a data signal; Wherein the polarizer is configured to be adjusted based at least in part on the polarization of the data signal, noise energy on the measurement area, and a signal-to-noise ratio (SNR). Wherein the polarizer is configured to be adjusted for a maximum signal-to-noise ratio (SNR) and to stop adjusting when the maximum SNR is reached. Wherein the polarizer is configured to pass greater than 50 percent of the data signal to the measurement area of the receiver; and wherein the polarizer is further configured to pass less than 50 percent of a horizontally polarized visible light from the one or more sources.

Another embodiment may be a method of communicating using visible light, characterized by improved range and data rate, the method comprising: by a visible light transmitter and a visible light receiver; the receiver being configured to use at least one polarizer; transmitting, by a visible light transmitter, a data signal; receiving visible light energy, from multiple sources through a polarizer, wherein at least one sources transmits a data signal; adjusting at least one polarizer, based at least in part on the transmitted data signal and a noise energy; and maximizing a signal-to-noise ratio (SNR) of the received visible light energy, wherein adjusting the at least one polarizer is stopped when SNR is maximized. Wherein at least one of the sources is a light emitting diode. Wherein the polarizers are an electronic shudder polarizer. Wherein the polarizer adjustment is adjusted using a rotating polar filter. Wherein the polarizer adjustment is based at least in part on a desired signal to noise ratio. Wherein the polarizer adjustment is further adjusted based on a variation in the angle of the received noise energy. Wherein the polarizer adjustment corresponds to gains relating to I_{Tx}=I_{Inc} cos² θ.

It is an object to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration of one embodiment of a visible light communication (VLC) system.

FIG. 2 is an illustration of one embodiment of a polar filtering communication system.

FIG. 3 is an illustration showing one implementation of a linear polarizer on a vehicle.

FIG. 4 is an illustration showing another implementation of a linear polarizer before a sensor.

FIG. 5 is a process flow diagram of one embodiment of data signal polarization filtering.

FIG. 6 is an illustration of a bar graph illustrating filtering results.

### DETAILED DESCRIPTION OF THE ILLUSTRATIVE EMBODIMENTS

In the following detailed description of various embodiments of the present disclosure, numerous specific details are set forth in order to provide a thorough understanding of various aspects of one or more embodiments of the present disclosure. However, one or more embodiments of the present disclosure may be practiced without some or all of these specific details. In other instances, well-known methods, procedures, and/or components have not been described in detail so as not to unnecessarily obscure aspects of embodiments of the present disclosure.

While multiple embodiments are disclosed, still other embodiments of the devices, systems, and methods of the present disclosure will become apparent to those skilled in the art from the following detailed description, which shows and describes illustrative embodiments of the devices, systems, and methods of the present disclosure. As will be realized, the devices, systems, and methods of the present disclosure are capable of modifications in various obvious aspects, all without departing from the spirit and scope of the present disclosure. Accordingly, the screenshot figures, and the detailed descriptions thereof, are to be regarded as illustrative in nature and not restrictive. Also, the reference or non-reference to a particular embodiment of the devices, systems, and methods of the present disclosure shall not be interpreted to limit the scope of the present disclosure.

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers, or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 0.001-10% from the indicated number or range of numbers.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

Furthermore, the one or more versions may be implemented as a method, apparatus, or article of manufacture using standard programming and/or engineering techniques to produce entirely hardware embodiment, an entirely software embodiment, or an embodiment combining software and hardware embodiments. Furthermore, the systems and methods may take the form of non-transitory computer readable media. More particularly, the present methods and systems may take the form of web-implemented computer software or a computer program product. Any suitable computer-readable storage medium may be utilized including, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick).

Those skilled in the art will recognize many modifications may be made to this configuration without departing from the scope of the disclosed embodiments.

Embodiments of the systems and methods are described below with reference to schematic diagrams, block diagrams, and flowchart illustrations of methods, systems, apparatuses and computer program products. It will be understood that each block of the block diagrams, schematic diagrams, and flowchart illustrations, and combinations of blocks in the block diagrams, schematic diagrams, and flowchart illustrations, respectively, may be implemented by computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, may be implemented by special purpose hardware-based computer systems that perform the specified functions or steps, or combinations of special purpose hardware and computer instructions.

In the following description, certain terminology is used to describe certain features of the various embodiments of the device, method, and/or system. For example, as used herein, the terms “computer” and “computer system” generally refer to any device that processes information with an integrated circuit chip and/or central processing unit (CPU).

As used herein, the terms “software” and “application” refer to any set of machine-readable instructions on a machine, web interface, and/or computer system” that directs a computer's processor to perform specific steps, processes, or operations disclosed herein.

As used herein, the term “computer-readable medium” refers to any storage medium adapted to store data and/or instructions that are executable by a processor of a computer system. The computer-readable storage medium may be a computer-readable non-transitory storage medium and/or any non-transitory data storage circuitry (e.g., buggers, cache, and queues) within transceivers of transitory signals. The computer-readable storage medium may also be any tangible computer readable medium. In various embodiments, a computer readable storage medium may also be able to store data, which is able to be accessed by the processor of the computer system.

As used herein, the term “candela” refers to a unit of luminous intensity in the International System of Units (SI), defined as the luminous intensity in a given direction of a source that emits monochromatic radiation and has a radiant intensity in that same direction of 1/683 watt per steradian (unit solid angle).

As used herein, the term “polarization” refers to a property of transverse waves that specifies the geometrical orientation of the oscillations.

As used herein, the term “signal-to-noise ratio” refers to a measure used in science and engineering that compares the desired signal level to the background noise level.

As used herein, the term “visible light” refers to the part of the electromagnetic spectrum that humans can see having wavelengths from 380 to 700 nanometers.

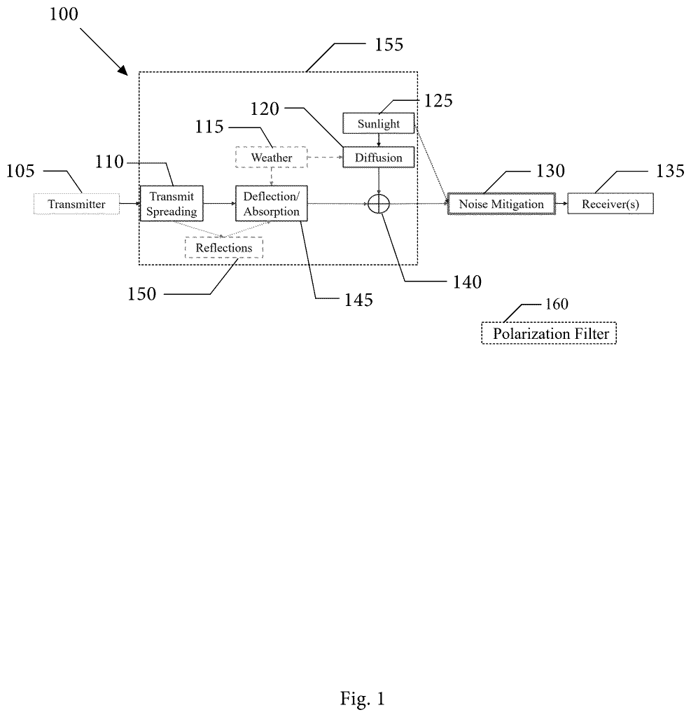

FIG. 1 is an illustration of one embodiment of a visible light communication (VLC) system. VLC communication system 100 may include transmitter 105, channel 155, and receiver 135.

VLC transmitter 105 may be but should not be limited to an electronic device that converts information (like sound, data, or video) into transmitted energy or a data signal that may be transmitted through channel 155, preferably taking a message and transforming it into a form suitable for transmission over a distance, typically using but not limited to radio waves, light pulses, or other electromagnetic signals; the primary function being to send information from one point to another. VLC transmitter 105 may utilize, but should not be limited to, light-emitting diodes (LEDs), Laser diodes, Fabry-Perot (F-P) lasers, distributed feedback (DFB) lasers, vertical-cavity surface-emitting lasers (VCSELs), and broadband light sources. LEDs may be cheaper and easier to use than laser diodes, but they have lower light power. Lasers may be able to transmit more light power than LEDs. Laser-based systems may be faster than LED-based systems. Broadband light sources emit light across a wide range of wavelengths and may typically be used to transmit large amounts of data. Transmitter 105 should preferably be able to modulate a light signal to represent different symbols. Modulation techniques typically vary the light signal's intensity around a positive DC value that provides lighting.

In one embodiment, VLC transmitter 155 may be a dual-use or a dual-purpose visible light source. Dual use or dual purpose may be but should not be limited to providing communications and/or light for an area or an object.

Communicating information signals across a distance typically propagates through some form of pathway or medium. These pathways, channel 155, may use a transmission medium such as a wire, waveguide, optical guide, free space, or a logical connection over a multiplexed medium such as a telecommunications and computer networking radio channel. Channel 155 may be used for information transfer but should not be limited to continuous data signal or a digital bit stream from one or several senders to one or several receivers. Channel 155 may have a certain capacity for transmitting information, often measured by its Hz bandwidth or data rate in bits per second. Channel 155 may also comprise sources of interference or noise such as but not limited to weather 115, transmit spreading 110, deflection absorption 145, reflections 150, sunlight 125, and diffusion 120. Sources of interference or noise energy may interfere with a receiver 135 or degrade the transmitted signal, increasing distortion and error rates. Additional energy or light sources, such as but not limited to artificial light, sun, solar, or any other energy sources, may contribute to interference and noise.

Receiver 135 may be but should not be limited to an electronic device that receives or senses transmitted energy or data signals and converts and decodes the transmitted energy or data signal into a usable form, essentially translating the received data signal back into the original information intended by the sender, like sound, data, or video, that the intended recipient or device can understand or interpret. Receiver 135 is preferably configured to receive transmitted energy such as but not limited to radio waves, light pulses, or other electromagnetic signals, the primary function being to receive information.

In one embodiment, receiver 135 may be, but it should not be limited to advanced driver assistance systems, such as ADAS cameras.

In some instances, interference or noise such as but not limited to weather 115, transmit spreading 110, deflection absorption 145, reflections 150, sunlight 125, and diffusion 120 may degrade or interfere with receiver 125 ability to convert or decode a signal into a usable form. Noise mitigations 130 may improve the ability of receiver 135 to convert or decode a signal and potentially improve rates and distances at which receiver 135 may operate reliably. Noise mitigations 130 may include but should not be limited to filtering, amplifying, attenuating, post-receiving signal processing, and data error correction.

Filtering of noise mitigation 130 may include but should not be limited to polarization filter 160. Polarization filter 160 may improve signal-to-noise ratio (SNR) in VLC. Polarization filter 160 may allow energy waves, such as but not limited to visible light waves, oscillating or vibrating in a specific direction to pass through, effectively filtering out energy waves oscillating or vibrating in perpendicular directions, which may result in the reduction of noise and reflections from noise sources affecting the measurement or identification of a data signal from VLC transmitter 105.

In one embodiment, a sensor may be a visible light sensor such as but not limited to CMOS sensors, photodiodes, phototransistors, photomultipliers, photovoltaic cells, photoresistors, pin diodes, or CCDs. A visible light sensor may be an array that may further include micro-lenses that may concentrate light on individual photo sites. Polarization filter 160 may be used to enhance the data signal blocks data signals not in a desired polarization.

Transmitted light intensity through polarization filter 160 may be represented analytically by Malus' Law

$${I}_{T x} = {I}_{inc} {cos}^{2} θ$$

where the transmitted intensity from the filter, I_{Tx}, is the incident intensity, I_{inc}, scaled by the cosine squared of the angle, θ, between the polarizer and the polarization of the incident light. In an unpolarized situation, there may be a uniform distribution of polarization angles in the incident light and a net transmission with a 50% arriving intensity. With an appropriate selection of θ, the polarized light may be dramatically suppressed within the limitations of polarizing filter 160. For the line of sight (LOS) path in daylight, this may offer significant suppression of solar irradiance compared to the data signal. Polarization filter 160 may significantly increase contrast ratio and improve ranges using low power transmitters at ranges demonstrated up to 550 meters.

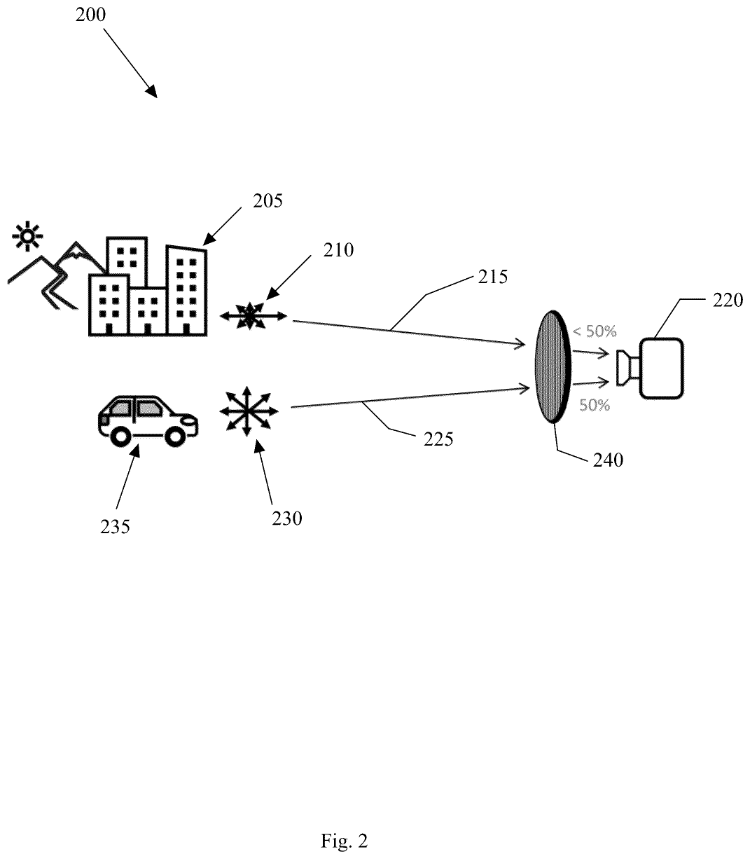

FIG. 2 is an illustration of one embodiment of a polar filtering communication system. A polar filter communication system 200 may include transmitter 235, data signal 230, direct path 225, scattering environment 205, noise 210, noise path 215, polarizer 240, and receiver 220.

Light scattering is an optical phenomenon that occurs when light interacts with scattering environment 205 and may be scattered by but not limited to buildings, pollutants, mountains, and particles or irregularities in a medium, causing it to reflect or change direction. Scattering may happen when light hits an object and bounces off in one or more directions, such as noise path 215. Scattered noise 210 may be received at receiver 220 from multiple noise paths 215.

Transmitter 235 may be any light source capable of converting information (like sound, data, or video) into transmitted energy or data signal 230. Transmitter 235 may transmit vertical, horizontal, or circular polarized data signal 230. Transmitter 235 may be a system having a primary purpose such as but not limited to providing light to an area or volume and be utilized to transmit data signal 230. For example, light emitting diodes (LEDs) may primarily be used to provide light to a user in a vehicle and also modulated to transmit data by rapidly switching the brightness high and low at a high frequency, essentially creating a pattern of light pulses that represent binary data (ones and zeros), which can be detected by receiver 220 and decoded back into the original information; this process may be imperceptible to the human eye due to the high modulation speed and is commonly referred to as “intensity modulation” or “pulse width modulation” (PWM).

LEDs have shown rapid advances. LED light sources typically produce unique spectrums that may be distinguishable from sunlight and noise sources. This may improve filtering by allowing the separation of data signals from noise and background sunlight. Typical noise sources and traditional light sources, such as but not limited to headlights and streetlamps, are typically unpolarized, which also allows for the filtering of non-data signal energy.

Data signal 230 may be either vertically or horizontally polarized, depending on the direction of oscillation of a wave. Either vertical or horizontal may be chosen depending on the environment and the predominant noise 210 source polarization. For example, if noise 210 has a predominant horizontal component, data signal 230 may preferably be vertically polarized, which may allow for horizontal noise 210 components to be filtered or blocked from receiver 220. Alternatively, if noise 210 has a vertical predominant element, data signal 230 may preferably be horizontally polarized, allowing vertical noise 210 components to be filtered or blocked from receiver 220.

In one embodiment, the polarization of transmitter 235 may be adjusted by using a dedicated polarizing filter or a specially designed LED that allows for manipulation of the polarization axis.

Receiver 220 is preferably configured to receive transmitted energy from transmitter 235. Receiver 220 may be configured with a polarizer 240 or may be modified to include a polarizer 240. The amount of noise 210 that reaches receiver 220 is preferred to be limited but still maximize the probability of receiving data signal 230. In order to increase the probability of receiving data signal 230 the field of view (FOV) should be as large as possible which may also deleteriously increase received noise 210. For example, a typical vehicle camera usually has a field of view (FOV) ranging between 120 and 170 degrees, which means that 67 to 95 percent of available FOV for a forward-looking receiver 220 is available to receive data signal 230 and noise 210.

Noise 210, such as but not limited to background light emitted by the sun, a lamp, or a candle flame, is typically not uniformly polarized, which means noise 210 energy may have both horizontal and vertical propagation components. If either component of orientation is blocked or filtered approximately 50 percent of noise 210 energy may be excluded from measurement within receiver 220. Noise 210 may become partially polarized after reflecting off the surface of scattering environment 205, and reflected noise 210 is typically horizontal polarization. This is because the surface absorbs or refracts the vertical components of noise 210. Spectral reflections are typically polarized in the same plane as the surface (the road or terrain). Volumetric effects of repeated scattering may also produce polarization perpendicular to the path of noise 210. For example, when the sun is overhead, light scattering perpendicular to its path to the ground is horizontally polarized. Due to the background having a stronger horizontal component than an unpolarized source, less than 50% of the incident light is passed when it is passed through polarizer 240 if vertically polarized. As shown in FIG. 2, more of the desired data signal 230 is passed than noise 210, which may be the dominant noise source in a visible light communication system, thereby increasing SNR.

Polarizer 240 may be either a vertical or a horizontal linear polarizer, allowing approximately 50% of the associated and polarized data signal 230 energy to pass through. Alternatively, polarizer 240 may be electronically or mechanically controlled or adjusted to vary the degree of vertical or horizontal polarization to maximize signal-to-noise ratio (SNR). As shown in FIG. 2 data signal 230 may be a vertically polarized signal on direct path 225 and polarizer 240 may pass approximately 50 percent of the total data signal 230 energy to receiver 220. Because noise 240 energy is typically not uniformly distributed through its polar regions, polarizer 240 may filter greater than 50 percent of noise 210 energy. Polarizer 240 may be adjusted or oriented to filter horizontal or vertical polarized noise 210.

In one embodiment, data signal 230 may include relative spectral components of noise 210 energy, such as sunlight and polarizer 240 may reduce the relative strength of noise 210. Scattering sunlight through the atmosphere can produce polarization of noise 210 such as the ambient scattered light. Calculated adjustments to polarizer 240 may depend on the angle and the scattering medium; for example, in clear skies, the maximum polarization may occur when viewing a signal horizontally with the sun directly overhead. Polarization from scattering may be maximized perpendicular to the transverse wave's propagation direction. For example, in a vehicle-to-vehicle visible-light-communication (VLC) system, a polarizer 240 filter may help separate data signal 230 from noise 210, such as scattered sunlight. Any improvements provided by filtering through polarization may depend on transmitter 235 characteristics, and variations in sun angle throughout the day may degrade any polarization gain, which may be addressed with an electronically adjustable polarizer 240.

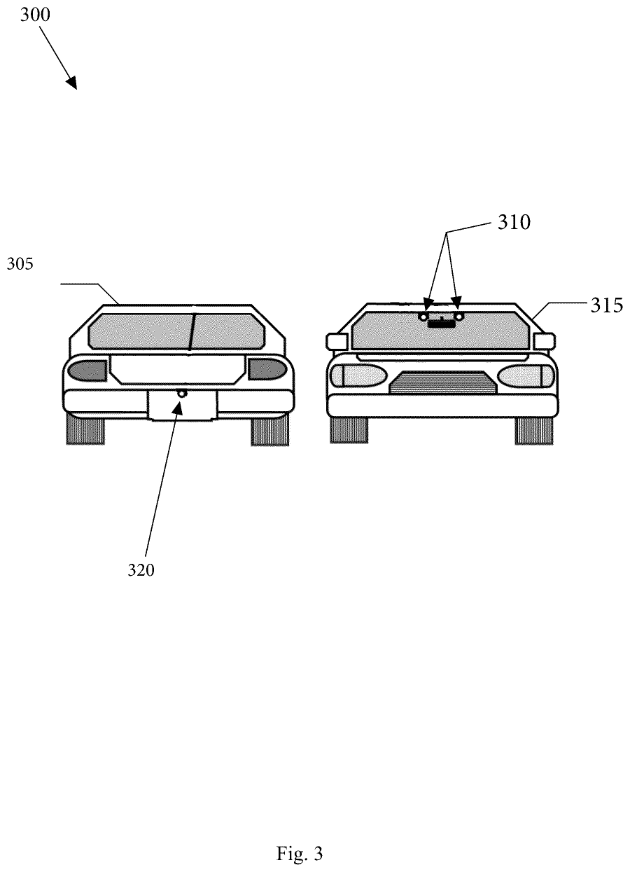

FIG. 3 is an illustration showing one implementation of a linear polarizer on a vehicle. As shown in FIG. 3, rear vehicle 305 and front vehicle 315 may each have a visible light communication (VLC) system, including rear camera 320 and one or more front camera 310.

A VLC system may have a primary purpose such as in advanced driver assistance systems (ADAS). ADAS cameras may be automotive camera sensors, which provide crucial information for assisting drivers with tasks such as but not limited to lane-departure warning, collision avoidance, lane-keeping assist, road departure mitigation, traffic sign recognition, forward collision warning, automatic emergency braking, adaptive cruise control, pedestrian detection, automatic high beams. ADAS cameras may service a dual purpose by being a receiver, such as receiver 220 in FIG. 2. Although shown as rear camera 320 and one or more front cameras 310, ADAS cameras vary in positioning based on the vehicle's design and features, including side cameras (not shown). By providing an array of ADAS cameras, VLC communications may not be limited to communications only in the rear vehicle 305 and the front vehicle 315.

In one embodiment, rear camera 305 may communicate driving parameters to one or more VLC systems, such as vehicle speed, speed changes, direction, lane changes, or any other useful information.

In one embodiment, front camera 315 may receive driving parameters from one or more VLC systems, such as but not limited to vehicle speed, speed changes, direction, lane changes, or any other useful information.

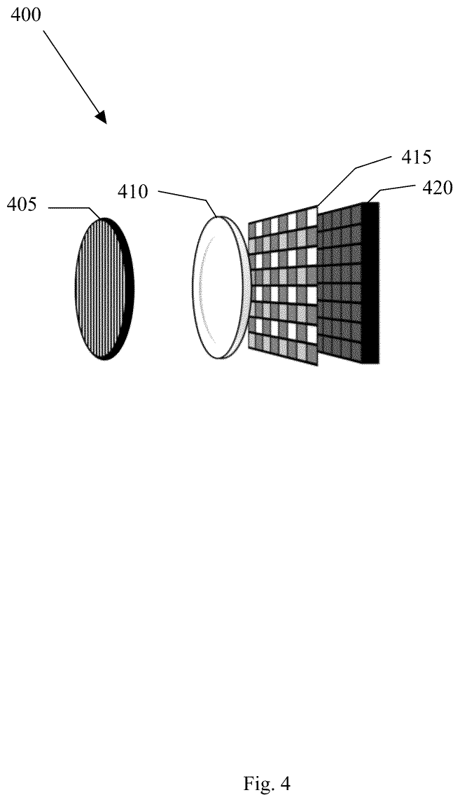

FIG. 4 is an illustration showing another implementation of a linear polarizer before a sensor. A polar filtering communication system 400 may include polarizer 405, lens 410, color filter 415, and sensor 420.

Polarizer 405 may be linear, where light may be filtered or blocked in a single plane. Typical polarizer 405 may be an optical filter that allows only light waves with a specific polarization to pass through while blocking all other polarization states. A linear optical polarizer is typically made by stretching a polymer film, such as but not limited to polyvinyl alcohol (PVA), which causes the long polymer molecules to align in one direction, then dyeing it with iodine to selectively absorb light waves oscillating perpendicular to the stretched direction, effectively allowing only light polarized parallel to the stretch axis to pass through; this process is often called “dichroic absorption.”

Lens 410 may be a standard camera lens with a focal length between 35 mm and 50 mm, similar to how the human eye views the world. Lens 410 captures may capture light free from distortion.

Color filter 415 may be an array that captures color information by selectively filtering different wavelengths of light, essentially separating the red, green, and blue components of an image; without color filters, a camera would only register the intensity of light without color distinction. Color filter 415 may also filter spectral components that differ from the data signal.

In one embodiment, communications may be demultiplexed by separating channels such as but not limited to red, green, or blue spectrum channels.

Sensor 420 may be a visible light sensor such as but not limited to CMOS sensors, photodiodes, phototransistors, photomultipliers, photovoltaic cells, photoresistors, pin diodes, or CCDs.

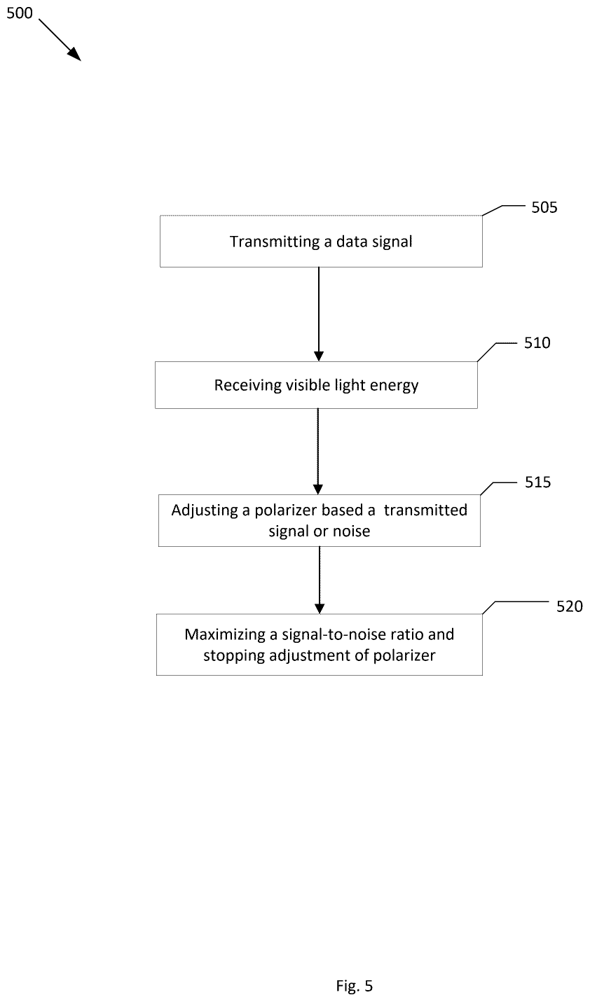

FIG. 5 is a process flow diagram of one embodiment of data signal polarization filtering.

One embodiment of communicating using visible light 500, characterized by the improved range and data rate, may include transmitting 505, by a visible light transmitter, a data signal; receiving visible light energy 510, from one or more sources through a polarizer, wherein at least one or more sources transmits a data signal; adjusting a polarizer 515, based at least in part on the transmitted data signal and noise energy; and maximizing a signal-to-noise ratio (SNR) 520 of the received visible light energy, and stop adjusting the polarizer when SNR is maximized.

In one embodiment, the polarizer may be an electronic shudder polarizer. An electronic shudder polarizer may be electronically controlled and adjusted to vary the amount of filtering and the linear angle of a polarizer. By varying an electronic shudder, a polarizer may control the amount of noise and data signal energy allowed to pass through to a receiver sensor. Controlling the linear angle of the polarizer, a VLC system may control the amount of noise filtered and blocked from passing through a receiver's sensor. By controlling an electronic shudder and or the linear angle of a polarizer, the SNR of a VLC may be maximized.

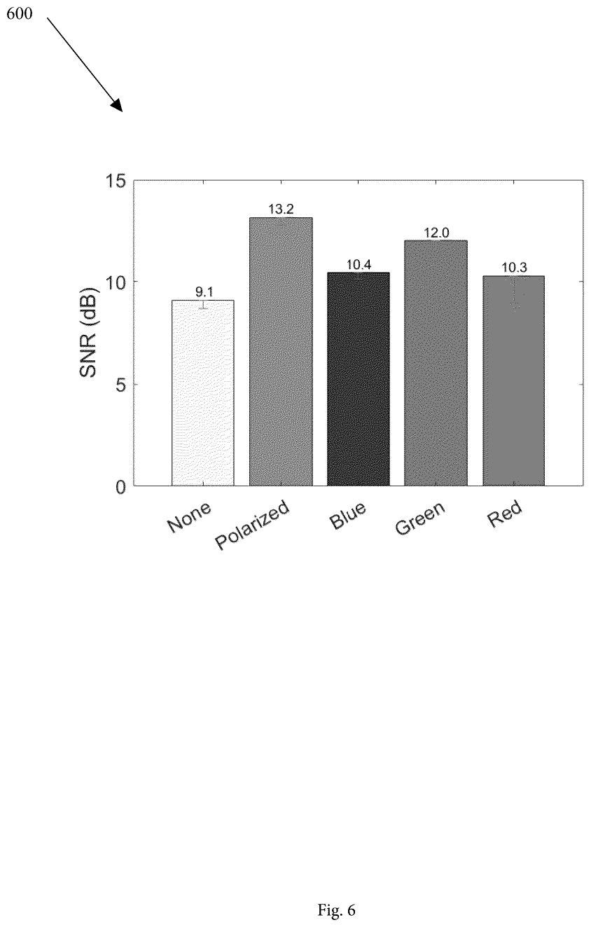

FIG. 6 is an illustration of a bar graph illustrating filtering results. FIG. 6 shows SNR measurements of the received data signal at 130 meters with red, green, blue, and polarized filters, along with an unfiltered result. As shown in FIG. 6, color and polarizing filters improve SNR. Green provided an increase in SNR of about twice as many decibels as that of red or blue visible color filters. Red, blue, and green color filters reduced the overall noise energy reaching a CMOS sensor, which may provide an opportunity for higher granularity in between the dark and the brightest areas of the scene during quantization.

As shown in FIG. 6, a polarizing filtering may offer gains of over four decibels compared to an unfiltered configuration. Low-powered sources should be able to transmit data embedded in polarization at long ranges.

Unless otherwise stated, all measurements, values, ratings, positions, magnitudes, sizes, locations, and other specifications that are set forth in this specification, including in the claims that follow, are approximate, not exact. They are intended to have a reasonable range that is consistent with the functions to which they relate and with what is customary in the art to which they pertain.

Some portions of the preceding detailed descriptions have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it should be appreciated that throughout the present disclosure, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display devices.

The processes or methods depicted in the figures may be performed by processing logic that comprises hardware (e.g., circuitry, dedicated logic, etc.), firmware, software (e.g., embodied on a non-transitory computer readable medium), or a combination thereof. Although the processes or methods are described above in terms of some sequential operations, it should be appreciated that some of the operations described may be performed in a different order. Moreover, some operations may be performed in parallel rather than sequentially.

In addition, the various illustrative logical blocks, modules, and circuits described in connection with certain embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, system-on-a-chip, or state machine. A processor may also be implemented as a combination of computing devices, e.g., a combination of a DSP and a microprocessor, a plurality of microprocessors, one or more microprocessors in conjunction with a DSP core, or any other such configuration.

Operational embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, a DVD disk, or any other form of storage medium known in the art. An exemplary storage medium is coupled to the processor such the processor may read information from, and write information to, the storage medium. In the alternative, the storage medium may be integral to the processor. The processor and the storage medium may reside in an ASIC or may reside as discrete components in another device.

Furthermore, the one or more versions may be implemented as a method, apparatus, or article of manufacture using standard programming and/or engineering techniques to produce software, firmware, hardware, or any combination thereof to control a computer to implement the disclosed embodiments. Non-transitory computer readable media may include but are not limited to magnetic storage devices (e.g., hard disk, floppy disk, magnetic strips), optical disks (e.g., compact disk (CD), digital versatile disk (DVD)), smart cards, and flash memory devices (e.g., card, stick). Those skilled in the art will recognize many modifications may be made to this configuration without departing from the scope of the disclosed embodiments.

The foregoing description of the preferred embodiment has been presented for the purposes of illustration and description. While multiple embodiments are disclosed, still other embodiments will become apparent to those skilled in the art from the above detailed description. These embodiments are capable of modifications in various obvious aspects, all without departing from the spirit and scope of protection. Accordingly, the detailed description is to be regarded as illustrative in nature and not restrictive. Also, although not explicitly recited, one or more embodiments may be practiced in combination or conjunction with one another. Furthermore, the reference or non-reference to a particular embodiment shall not be interpreted to limit the scope of protection. It is intended that the scope of protection not be limited by this detailed description, but by the claims and the equivalents to the claims that are appended hereto.

Except as stated immediately above, nothing that has been stated or illustrated is intended or should be interpreted to cause a dedication of any component, step, feature, object, benefit, advantage, or equivalent, to the public, regardless of whether it is or is not recited in the claims.

What is claimed is:

1. A visible light communication apparatus comprising:
one or more sources, at least one source being a light source configured to transmit a data signal; and
a receiver comprising a polarizer and operating in a visible light spectrum, the receiver configured to receive visible light energy from the one or more sources;
the polarizer configured to filter multiple noise signals and allow the data signal to pass through to the receiver.

2. The apparatus of claim 1, wherein the polarizer is configured to be adjusted based at least in part on the polarization of the data signal, multiple noise signals, and a signal-to-noise ratio (SNR).

3. The apparatus of claim 1, wherein the polarizer is configured to be adjusted for a maximum signal-to-noise ratio (SNR) and to stop adjusting when the maximum SNR is reached.

4. The apparatus of claim 1, wherein the polarizer is an electronic shudder polarizer.

5. The apparatus of claim 1, wherein the polarizer is a rotating polar filter.

6. The apparatus of claim 1, wherein at least one of the one or more sources is a light emitting diode.

7. The apparatus of claim 2, wherein a polarizer adjustment is based at least in part on a desired signal to noise ratio.

8. The apparatus of claim 2, wherein the polarizer adjustment is further adjusted based on a variation in the angle of the received noise energy.

9. The apparatus of claim 2, wherein the polarizer adjustment corresponds to gains relating to I_{Tx}=I_{Inc} cos² θ.

10. A vehicle comprising a visible light communication apparatus, where the visible light communication apparatus comprises:
a receiver;
one or more sources; and
a polarizer;
the receiver being configured to receive a data signal and noise through a polarizer;
wherein the polarizer is configured to filter a multiple noise signals; and
wherein at least one of the one or more sources transmits a data signal.

11. The apparatus of claim 10, wherein the polarizer is configured to be adjusted based at least in part on the polarization of the data signal, noise energy on the measurement area, and a signal-to-noise ratio (SNR).

12. The apparatus of claim 10, wherein the polarizer is configured to be adjusted for a maximum signal-to-noise ratio (SNR) and to stop adjusting when the maximum SNR is reached.

13. The apparatus of claim 10, wherein the polarizer is configured to pass greater than 50 percent of the data signal to the measurement area of the receiver; and
wherein the polarizer is further configured to pass less than 50 percent of a horizontally polarized visible light from the one or more sources.

14. A method of communicating using visible light, characterized by improved range and data rate, the method comprising:
by a visible light transmitter and a visible light receiver; the receiver being configured to use at least one polarizer;
transmitting, by a visible light transmitter, a data signal;
receiving visible light energy, from one or more sources through a polarizer, wherein at least one or more sources transmits a data signal;
adjusting at least one polarizer, based at least in part on the transmitted data signal and a noise energy; and
maximizing a signal-to-noise ratio (SNR) of the received visible light energy, wherein adjusting the at least one polarizer is stopped when SNR is maximized.

15. The method of claim 14, wherein at least one of the one or more sources is a light emitting diode.

16. The method of claim 14, wherein the polarizer is an electronic shudder polarizer.

17. The method of claim 14, wherein the polarizer adjustment is adjusted using a rotating polar filter.

18. The method of claim 14, wherein the polarizer adjustment is based at least in part on a desired signal to noise ratio.

19. The method of claim 14, wherein the polarizer adjustment is further adjusted based on a variation in the angle of the received noise energy.

20. The method of claim 14, wherein the polarizer adjustment corresponds to gains relating to I_{Tx}=I_{Inc} cos^{2 θ.}
